(19) United States
(12) Patent Application Publication
(10) Pub. No.: US 2006/0149487 A1
(43) Pub. Date: Jul. 6, 2006

(54) System and method for reviewing quality control of instruments performing laboratory tests in a computerized environment

(76) Inventors: Jeffrey D. Fry, Lansing, KS (US); Lori N. Cross, Kansas City, MO (US); Arthur J. Hauck, Kansas City, MO (US)

Correspondence Address: SHOOK, HARDY & BACON L.L.P.;Intellectual Property Department, 2555 GRAND BOULEVARD, KANSAS CITY, MO, 64108-2613, US

(21) Appl. No.: 11/025,097

(22) Filed: Dec. 29, 2004

(51) Int. Cl. G06F 19/00

(52) U.S. Cl. 702/81

(57) ABSTRACT

The present invention relates to a method and system for suspending the processing of laboratory test results in a computerized environment. One or more test results from an instrument in a healthcare laboratory are received. It is determined whether the instrument has had a quality control procedure performed within a predefined period. If not, the processing of the one or more test results is suspended until the quality control procedure has been performed on the instrument. If the quality control procedure has been performed within the predefined period, it is determined whether the quality control procedure performed indicates that the instrument is performing properly. If not, the processing of the one or more test results is suspended until the quality control issue is resolved.

### CROSS-REFERENCE TO RELATED APPLICATIONS

Not applicable.

### STATEMENT REGARDING FEDERALLY SPONSORED RESEARCH OR DEVELOPMENT

Not applicable.

### TECHNICAL FIELD

The present invention relates generally to the field of computer software. More particularly, the present invention relates to reviewing the quality control of laboratory instruments in a computerized environment.

### BACKGROUND OF THE INVENTION

Laboratory tests are ordered for a number of reasons. For example, healthcare providers order laboratory tests to be performed for a patient in a healthcare environment. Examples of these tests include analyzing fluid or bodily tissue, such as blood or urine. A fluid or tissue sample is taken from a patient and sent to a laboratory to be tested. One or more instruments within a laboratory perform ordered tests on the sample. After performing the tests, the instruments provide electronic messages with the test results.

It is important that the instruments used to perform the laboratory testing are operating within quality control standards. For example, quality control material is run on instruments at specified intervals to make sure that the instruments are performing correctly. An instrument tested with quality control material should produce a specified range of results to show that the instrument is operating properly.

Other systems have attempted to determine whether the instrument is within quality control standards. However, in these systems if it is determined that the instrument is not performing within quality control standards or within a quality control schedule, the laboratory test results are not automatically verified and the tests must be reperformed or manually reviewed. Automatic verification in these systems determines whether the instrument performing the laboratory test was within quality control standards or within a quality control schedule.

However, if the instrument is not operating within quality control standards or within a quality control schedule, these systems are unable to hold laboratory test results until the appropriate quality control has been performed on the instrument that has performed the test. The tests have to be reperformed or manually reviewed because the results have failed to be automatically verified. This process is time-consuming for laboratory technologists and wastes laboratory resources and reagents by reperforming all of the tests that fail to be automatically verified.

It would be beneficial to be able to hold laboratory test results when it is determined that the quality control schedule or the quality control has failed for a particular laboratory test result. It would also be beneficial to suspend any other processes while performing any necessary quality control measures and once the quality control issues have been resolved sending the test results on for additional processing.

### SUMMARY OF THE INVENTION

In one embodiment, a method of suspending the processing of laboratory test results in a computerized environment is provided. One or more test results from an instrument in a healthcare laboratory are received. It is determined whether the instrument has had a quality control procedure performed within a predefined period. If not, the processing of the one or more test results is suspended until the quality control procedure has been performed on the instrument. If the quality control procedure has been performed within the predefined period, it is determined whether the quality control procedure indicates that the instrument is performing properly.

In another embodiment, a system for suspending the processing of laboratory test results in a computerized environment. The system includes a receiving component for receiving one or more test results from an instrument in a healthcare laboratory. The system also includes a determining component for determining whether the instrument has had a quality control procedure performed within a predefined period and a suspending component for suspending the processing of one or more test results if a quality control procedure has not been performed on the instrument within the predefined period.

In yet another embodiment, system for suspending the processing of laboratory test results in a computerized environment is provided. The system includes means for receiving one or more test results from an instrument in a healthcare laboratory and means for determining whether the instrument has had a quality control procedure performed within a predefined period. The system also includes means for suspending the processing of one or more test results until the quality control procedure has been performed on the instrument.

### BRIEF DESCRIPTION OF THE SEVERAL VIEWS OF THE DRAWINGS

The present invention is described in detail with reference to the attached drawing figures, wherein:

FIG. 1 is a block diagram of a computing system environment suitable for use in implementing the present invention; and

FIG. 2 is a flow diagram of determining whether the instrument performing the laboratory test satisfies quality control in accordance with an embodiment of the present invention.

### DETAILED DESCRIPTION OF THE INVENTION

The present invention allows for laboratory test results to be held if the instrument that performed the test does not pass quality control standards or the quality control of the instrument has expired. The present invention allows a user to hold laboratory test results and suspend any processes for verifying that the results are within normal ranges while performing any necessary quality control measures or tests. Once any quality control issues have been resolved, the laboratory test results will be sent on for any additional processing. The present invention reduces user intervention, duplication of testing, wasted reagents/testing supplies and decreases turn around times in the laboratory.

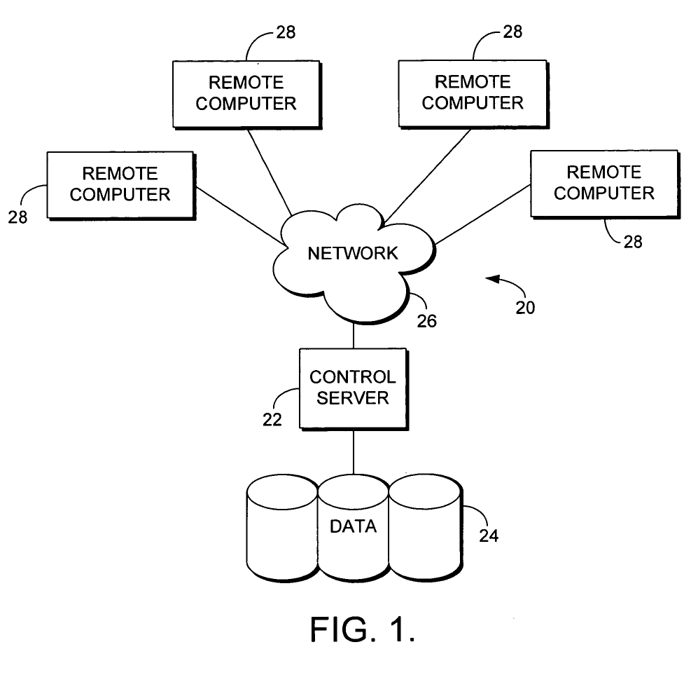

With reference to FIG. 1, an exemplary medical information system for implementing the invention includes a general purpose-computing device in the form of server 22. Components of server 22 may include, but are not limited to, a processing unit, internal system memory, and a suitable system bus for coupling various system components, including database cluster 24 to the control server 22. The system bus may be any of several types of bus structures, including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronic Standards Association (VESA) local bus, and Peripheral Component Interconnect (PCI) bus, also known as Mezzanine bus.

Server 22 typically includes therein or has access to a variety of computer readable media, for instance, database cluster 24. Computer readable media can be any available media that can be accessed by server 22, and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information, such as computer readable instructions, data structures, program modules or other data. Computer storage media includes, but is not limited to, RAM, ROM, EEPROM, flash memory or other memory technology, CD-ROM, digital versatile disks (DVD), or other optical disk storage, magnetic cassettes, magnetic tape, magnetic disk storage, or other magnetic storage devices, or any other medium which can be used to store the desired information and which can be accessed by server 22. Communication media typically embodies computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media such as acoustic, RF, infrared and other wireless media. Combinations of any of the above should also be included within the scope of computer readable media.

The computer storage media, including database cluster 24, discussed above and illustrated in FIG. 1, provide storage of computer readable instructions, data structures, program modules, and other data for server 22.

Server 22 may operate in a computer network 26 using logical connections to one or more remote computers 28. Remote computers 28 can be located at a variety of locations in a medical or research environment, for example, but not limited to, clinical laboratories, hospitals, other inpatient settings, a clinician's office, ambulatory settings, medical billing and financial offices, hospital administration, veterinary environment and home health care environment. Clinicians include, but are not limited to, the treating physician, specialists such as surgeons, radiologists and cardiologists, emergency medical technologists, physician's assistants, nurse practitioners, nurses, nurse's aides, pharmacists, dieticians, microbiologists, laboratory experts, genetic counselors, researchers, veterinarians and the like. The remote computers may also be physically located in non-traditional medical care environments so that the entire health care community is capable of integration on the network. Remote computers 28 may be a personal computer, server, router, a network PC, a peer device, other common network node or the like, and may include some or all of the elements described above relative to server 22. Computer network 26 may be a local area network (LAN) and/or a wide area network (WAN), but may also include other networks. Such networking environments are commonplace in offices, enterprise-wide computer networks, intranets and the Internet. When utilized in a WAN networking environment, server 22 may include a modem or other means for establishing communications over the WAN, such as the Internet. In a networked environment, program modules or portions thereof may be stored in server 22, or database cluster 24, or on any of the remote computers 28. For example, and not limitation, various application programs may reside on the memory associated with any one or all of remote computers 28. It will be appreciated that the network connections shown are exemplary and other means of establishing a communications link between the computers may be used.

A user may enter commands and information into server 22 or convey the commands and information to the server 22 via remote computers 28 through input devices, such as keyboards, pointing devices, commonly referred to as a mouse, trackball, or touch pad. Other input devices may include a microphone, satellite dish, scanner, or the like. Server 22 and/or remote computers 28 may have any sort of display device, for instance, a monitor. In addition to a monitor, server 22 and/or computers 28 may also include other peripheral output devices, such as speakers and printers.

Although many other internal components of server 22 and computers 28 are not shown, those of ordinary skill in the art will appreciate that such components and their interconnection are well known. Accordingly, additional details concerning the internal construction of server 22 and computer 28 need not be disclosed in connection with the present invention.

Although the method and system are described as being implemented in a WINDOWS operating system operating in conjunction with an Internet-based system, one skilled in the art would recognize that the method and system can be implemented in any system supporting the receipt and processing of laboratory test results.

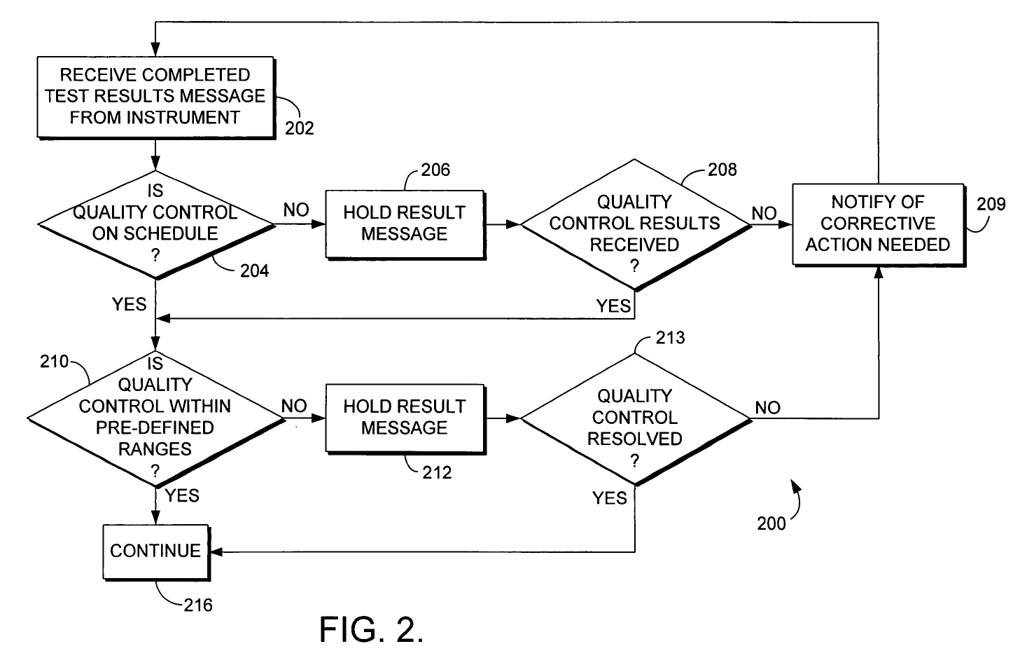

With reference to FIG. 2, a method for evaluating the quality control of an instrument that has produced laboratory test results 200 is shown. At block 202, one or more completed test results from an instrument in the laboratory are received. In one embodiment, the one or more completed laboratory test results are received in the form of an electronic message. At decision block 204, it is determined whether the instrument that has performed the laboratory test results is within a predefined quality control schedule. In one embodiment, the predefined quality control schedule for the laboratory instrument is accessed from a database or table. Quality control tests a laboratory instrument with a quality control material to see if the result produced indicates that the instrument is operating properly. Quality control material is run on instruments at specified intervals to make sure that the instruments are performing correctly as set forth with reference to the example below.

If at block 204 it is determined that the quality control has not been performed on the instrument within the predefined schedule, at block 206 the one or more laboratory test results received are placed on hold. A laboratory technologist may then perform the necessary quality control to comply with the predefined quality control schedule. For example, where the quality control is just short of being within the predefined schedule, the quality control scheduling issue can be resolved without having to reperform the one or more laboratory tests. This reduces reagents and testing supplies used and decreases turnaround time in the laboratory. These results are then transmitted to the system.

At decision block 208, it is determined whether any results from quality control tests performed by the lab technologist have been received. If the quality control results have not been received at decision block 208, a notification that corrective action is needed is sent. For example, the system notifies a technologist that the test for the completed test results received may need to be re-run at block 209. If, at decision block 208, it is determined that the quality control results have been received, the system proceeds to decision block 210.

If at decision block 204 it is determined that the quality control for the instrument is on schedule, the system proceeds to decision block 210. At decision block 210 it is determined whether the quality control performed for the instrument is within predefined ranges. For example, the system may be predefined to require that the instrument have a predefined quality control range. If at block 210 it is determined that the quality control is within predefined ranges, the system continues at block 216.

However, if at decision block 210 it is determined the quality control is not within the predefined quality control ranges, at block 212 the laboratory test result is held. The laboratory technologist may determine that even though the quality control of the instrument performing the laboratory test result is not within predefined ranges currently, at the time the laboratory test was performed it satisfied quality control. For example, the laboratory technologist may determine that the sampling probe on the laboratory instrument was partially obstructed causing the instrument's measurements to be inaccurate and this occurred after the laboratory test was performed. The technologist indicates that the laboratory instrument was in quality control at the time the test was performed and this is transmitted to the system. At decision block 213 it is determined whether the quality control issue has been resolved.

However, if at block 213 it is determined that the quality control issue cannot be resolved, at block 209, notification that corrective action is needed is sent and the result message is continued to be held. For example, the corrective action is that the patient sample will have to be rerun and the test for the test results message reperformed. However, if at block 213, the laboratory technologist has been able to resolve the quality control issues, the system continues at block 216 and the result message is released from being held. After the system continues at block 216, the laboratory test results may be sent through an automatic verification process. This automatic verification process will determine whether the laboratory test results received are within a predetermined acceptable range.

By way of example, not by limitation, the following is an example of evaluating the quality control of the instrument performing laboratory tests. A lipid profile procedure is ordered for fictitious patient John Smith and a sample of John Smith's blood is drawn. The lipid profile procedure consists of three instrument-performed detailed tasks including, a cholesterol test, a triglyceride test, and an HDL test. The detailed tests are performed on two different instruments or medical devices. For example, the cholesterol and triglyceride tests are performed on a VITROS 950 instrument. The HDL test is performed on a VITROS 250 instrument.

After each instrument performs the necessary tests on the sample received from fictitious patient John Smith, the results are sent as electronic messages and received at block 202 of FIG. 2. The exemplary message from the VITROS 950 instrument is “VITROS 950: cholesterol=250 mg/dl; triglycerides=150 mg/dl”. At block 204 of FIG. 2, it is determined whether the quality control of the VITROS 950 instrument has been performed within a predefined schedule. The predefined schedule for the VITROS 950 instrument is accessed from a database or table. In this example the quality control for the VITROS 950 instrument producing the laboratory test result has not been performed according to the predefined quality control schedule. Thus, the laboratory test result message is held at block 206. Meanwhile, the laboratory technologist performs the quality control procedure on the instrument to comply with the predefined quality control schedule and the quality control results are entered into the system. At block 208 it is determined whether quality control results have been received. At block 210 it is determined that the quality control results indicate that the instrument is performing accurately.

With reference to FIG. 2, at block 202, results for HDL test performed on a VITROS 250 instrument are received. At block 204, it is determined that the quality control procedure for the VITROS 250 instrument has been performed within a predefined schedule. At decision block 210 it is determined that the quality control result for the VITROS 250 instrument is not within a predefined range and is held at block 212. The laboratory technologist determines that the laboratory test yielding the results received at block 202 was performed before the instrument went out of quality control. The laboratory technologist determines that the sample probe of the VITROS 250 instrument was partially obstructed causing it to go out of quality control after the laboratory test was performed. As such, at block 213 it is determined that the quality control issue has been resolved and the system continues at block 216. However, if the laboratory technologist had determined that the sample probe of the VITROS 250 instrument was partially obstructed before the laboratory test was performed, the quality control issue would not be resolved at block 213 and notification is sent to a laboratory technology indicated that corrective action is needed, such as re-running the sample.

The present invention has been described in relation to particular embodiments, which are intended in all respects to illustrate rather than restrict. Alternative embodiments will become apparent to those skilled in the art that do not depart from its scope. Many alternative embodiments exist, but are not included because of the nature of this invention. A skilled programmer may develop alternative means for implementing the aforementioned improvements without departing from the scope of the present invention.

It will be understood that certain features and sub-combinations of utility may be employed without reference to features and sub-combinations and are contemplated within the scope of the claims.

The invention claimed is:

1. A method of suspending the processing of laboratory test results in a computerized environment, the method comprising:
receiving one or more test results from an instrument in a healthcare laboratory; and
determining whether the instrument has had a quality control procedure performed within a predefined period,
if not, suspending the processing of the one or more test results until the quality control procedure has been performed on the instrument.

2. The method of claim 1, wherein if the quality control procedure has been performed within the predefined period, determining whether the quality control procedure indicates that the instrument is performing properly.

3. The method of claim 2, wherein if the quality control procedure indicates that the instrument is performing properly, comparing the one or more test results to predefined criteria to determine whether the one or more test results are within a normal range.

4. The method of claim 3, wherein if the one or more test results are within a normal range, automatically verifying the one or more test results.

5. The method of claim 2, wherein if the quality control procedure indicates that the instrument is not performing properly, holding the one or more test results.

6. The method of claim 1, wherein the one or more test results are received as an electronic message from the instrument.

7. The method of claim 1, wherein the predefined period is accessed from a database.

8. The method of claim 1, wherein the one or more tests results are suspending by being placed on hold.

9. The method of claim 1, wherein the quality control procedure is performed by testing the instrument with one or more quality control materials.

10. A computer-readable medium comprising the method of claim 1.

11. A system for suspending the processing of laboratory test results in a computerized environment, the system comprising:
a receiving component for receiving one or more test results from an medical instrument;
a determining component for determining whether the instrument has had a quality control procedure performed within a predefined period; and
a suspending component for suspending the processing of the one or more test results if a quality control procedure has not been performed on the instrument within the predefined period.

12. The system of claim 11, wherein the determining component determines whether the quality control procedure indicates that the instrument is performing properly if the quality control procedure has been performed within the predefined period.

13. The system of claim 11, further comprising:
a comparing component for comparing the one or more test results to predefined criteria to determine whether the one or more test results are within a normal range if the quality control procedure indicates the instrument is performing properly.

14. The system of claim 13, further comprising:
a verifying component for automatically verifying the one or more test results if the one or more test results are within an acceptable range.

15. The system of claim 12, further comprising:
a holding component for holding the one or more test results if the quality control procedure indicates the instrument is not performing properly.

16. The system of claim 1, wherein the receiving component receives the one or more test results.

17. The system of claim 11, wherein the suspending component suspends the one or more tests results by placing them on hold.

18. The system of claim 11, wherein the quality control procedure is performed by testing the instrument with one or more quality control materials.

19. A system for suspending the processing of laboratory test results in a computerized environment, the system comprising:
means for receiving one or more test results from a medical instrument;
means for determining whether the instrument has had a quality control procedure performed within a predefined period; and
means for suspending the processing of the one or more test results until the quality control procedure has been performed on the instrument.

20. The system of claim 19, wherein if the quality control procedure has been performed within the predefined period, determining whether the quality control procedure indicates that the instrument is performing properly.

21. The system of claim 20, wherein if the quality control procedure indicates that the instrument is performing properly, comparing the one or more test results to predefined criteria to determine whether the one or more test results are within a normal range.

22. The system of claim 21, wherein if the one or more test results are within a normal range, automatically verifying the one or more test results.

23. The system of claim 20, wherein if the quality control procedure indicates that the instrument is not performing properly, holding the one or more test results.
